(19) United States
(12) Patent Application Publication
(10) Pub. No.: US 2012/0141105 A1
(43) Pub. Date: Jun. 7, 2012

(54) THREE-DIMENSIONAL IMPLEMENTATION CAMERA MODULE

(75) Inventor: Hyung Keun LEE, Gyeonggi-do (KR)

(73) Assignee: Samsung Electro-Mechanics Co., Ltd., Suwon (KR)

(21) Appl. No.: 13/312,432

(22) Filed: Dec. 6, 2011

(30) Foreign Application Priority Data
Dec. 7, 2010 (KR) 10-2010-0123978

(51) Int. Cl. G03B 35/00

(52) U.S. Cl. 396/324

(57) ABSTRACT

Disclosed herein is a three-dimensional (3D) implementation camera module, and more particularly, a 3D implementation camera module capable of implementing a 3D stereoscopic image using a single camera module by providing two lenses in a single barrel and allowing a sensor to alternately sense images input through the two lenses using a blocking film. The 3D implementation camera module includes: a barrel; at least two lenses embedded in the barrel; a blocking film provided in the barrel to thereby alternately block the lenses; and a sensor provided on a lower portion of the barrel to thereby sense images alternately input from the lenses.

### CROSS REFERENCE(S) TO RELATED APPLICATIONS

This application claims the benefit under 35 U.S.C. Section 119 of Korean Patent Application Serial No. 10-2010-0123978, entitled “Three-Dimensional Implementation Camera Module” filed on Dec. 7, 2010, which is hereby incorporated by reference in its entirety into this application.

### BACKGROUND OF THE INVENTION

1. Technical Field

The present invention relates to a three-dimensional (3D) implementation camera module, and more particularly, to a 3D implementation camera module capable of implementing a 3D stereoscopic image using a single camera module by providing two lenses in a single barrel and allowing a sensor to alternately sense images input through the two lenses using a blocking film.

2. Description of the Related Art

FIG. 1 shows a structure of a camera module according to the related art. As shown in FIG. 1, the camera module according to the related art is configured to include a barrel 1, a lens 2 provided in the barrel 1, and a sensor 3 sensing images of a subject for photography input to the lens 2. The sensor 3 may be mounted on a printed circuit board (PCB) 4 to convert and process the sensed images into an electrical signal, or the like.

That is, the camera module according to the related art has a structure in which the printed circuit board 4 is attached to the sensor 3 and includes the barrel 1 and the lens 2 disposed on an upper surface thereof. In this scheme, images of the subject for photography are taken by applying a single sensor to a single lens.

However, since the camera module according to the related art obtains image information through the single lens, it is impossible to obtain or implement an image having perspective such as a 3D stereoscopic image.

Therefore, according to the related art, in order to implement the 3D stereoscopic image, a process of photographing images using two cameras and then alternating the images photographed using the two cameras should be performed.

### SUMMARY OF THE INVENTION

An object of the present invention is to provide a camera module capable of implementing a 3D image using a simple configuration.

According to an exemplary embodiment of the present invention, there is provided a three-dimensional (3D) implementation camera module including: a barrel; at least two lenses embedded in the barrel; a blocking film provided in the barrel to thereby alternately block the lenses; and a sensor provided on a lower portion of the barrel to thereby sense images alternately input from the lenses.

The blocking film may rotate within the barrel to thereby alternately block the lenses.

The blocking film may be mounted on a rail provided in the barrel to move linearly, thereby alternately blocking the lenses.

The blocking films having the same number as the number of lenses and made of an opaque material may be provided between the lenses and the sensor and be alternately changed to be transparent by an electrical signal.

### BRIEF DESCRIPTION OF THE DRAWINGS

FIG. 1 is a perspective view showing a camera module according to the related art; and

FIGS. 2 to 4 are perspective views showing a camera module according to an exemplary embodiment of the present invention.

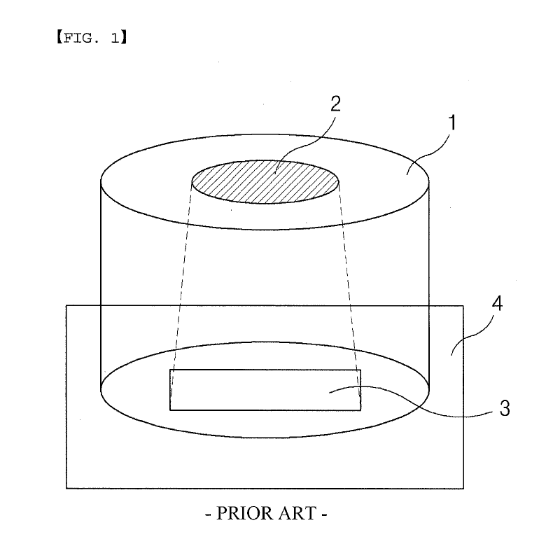

### DESCRIPTION OF THE PREFERRED EMBODIMENTS

Hereinafter, exemplary embodiments of the present invention will be described in detail with reference to the accompanying drawings. The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

Therefore, the configurations described in the embodiments and drawings of the present invention are merely most preferable embodiments but do not represent all of the technical spirit of the present invention. Thus, the present invention should be construed as including all the changes, equivalents, and substitutions included in the spirit and scope of the present invention at the time of filing this application.

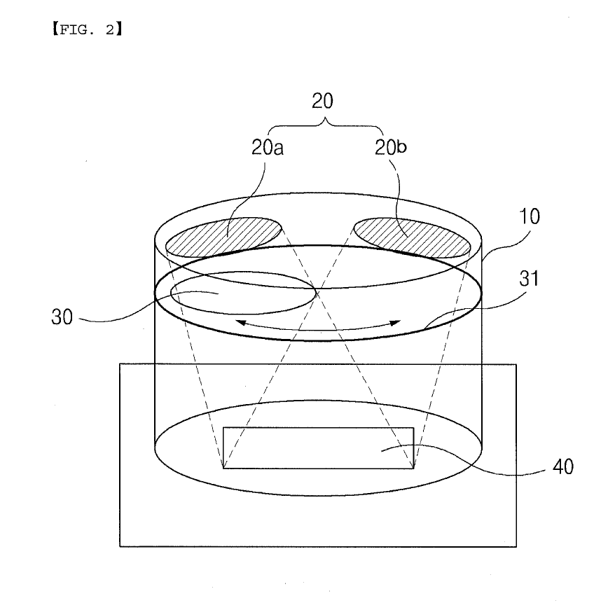

FIGS. 2 to 4 are perspective views showing a camera module according to an exemplary embodiment of the present invention. As shown in FIGS. 2 to 4, the camera module according to the exemplary embodiment of the present invention is configured to include a barrel 10, at least two lenses 20, a blocking film 30, and a sensor 40.

The barrel 10, which means a case used in a camera module in order to maintain a distance between an objective lens and an ocular lens at a constant length, may have a cylindrical shape.

The lens 20, which is a transparent glass body refracting light reflected from a subject for photography, is provided in a camera and corresponds to a component to which images of the subject for photography are input. According to the exemplary embodiment of the present invention, at least two lenses are provided in the barrel 10 in order to implement a three-dimensional (3D) stereoscopic camera. That is, as shown in FIGS. 2 to 4, a left lens 20a and a right lens 20b are provided, such that the images of the subject for photography are simultaneously input to the left lens 20a and the right lens 20b. Although the accompanying drawings show that two lenses are provided by way of example, three or more lenses may be provided if needed.

The blocking film 30, which is a simple component according to the exemplary embodiment of the present invention, alternately blocks the images of the subject for photography input to the left and right lenses 20a and 20b. According to the related art, two cameras have been basically required in order to implement a 3D stereoscopic image. More specifically, the 3D stereoscopic image has been implemented by alternating images photographed using two cameras disposed in parallel with each other on the left and the right to combine the left image and the right image with each other. However, this scheme has disadvantages in that two cameras are required and it is difficult to implement a 3D image due to the necessity of separate additional combining work.

Therefore, according to the embodiment of the present invention, the blocking film 30 serves to alternately block the lenses so as to allow the sensor 40 to alternately sense the images input to the lenses while continuously photographing the images using at least two lenses 20. Hereinafter, examples of the blocking film 30 will be described with reference to FIGS. 2 to 4.

As shown in FIG. 2, in a first example of the blocking film 30, the blocking film 30 rotates within the barrel 10 to thereby alternately block the lenses. That is, the blocking film 30 alternately blocks between the lenses 20 and the sensor 40 while rotating along a rotation orbit 31 within the barrel 10 based on a predetermined rotation center to thereby prevent the images input to the lenses from being sensed by the sensor 40. That is, the first example uses a simple principle in which the images are input to the lenses but are not sensed by the sensor.

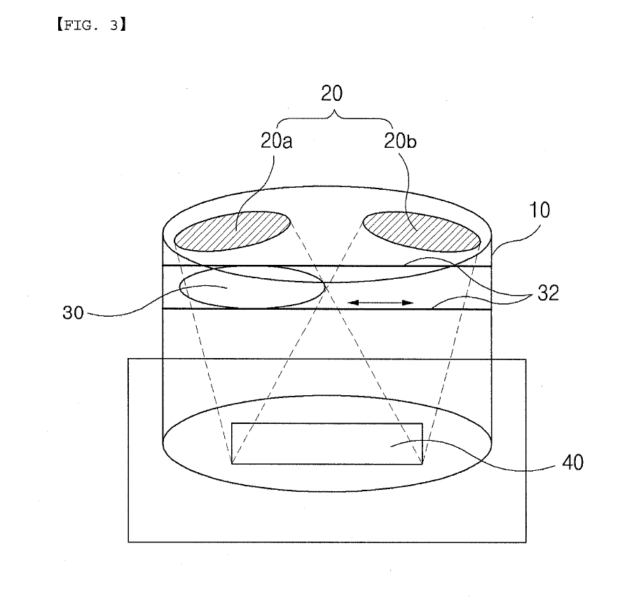

As shown in FIG. 3, in a second example of the blocking film 30, the blocking film 30 is mounted on a rail 32 provided within the barrel 10 to move linearly, thereby alternately blocking the lenses 20. That is, the blocking film 30 mounted on the rail 32 alternately blocks between the lenses 20 and the sensor 40 while moving linearly along an orbit of the rail 32 within the barrel 10 to thereby prevent the images input to the lenses from being sensed by the sensor 40. The second example also uses a simple principle in which the images are input to the lenses but are not sensed by the sensor.

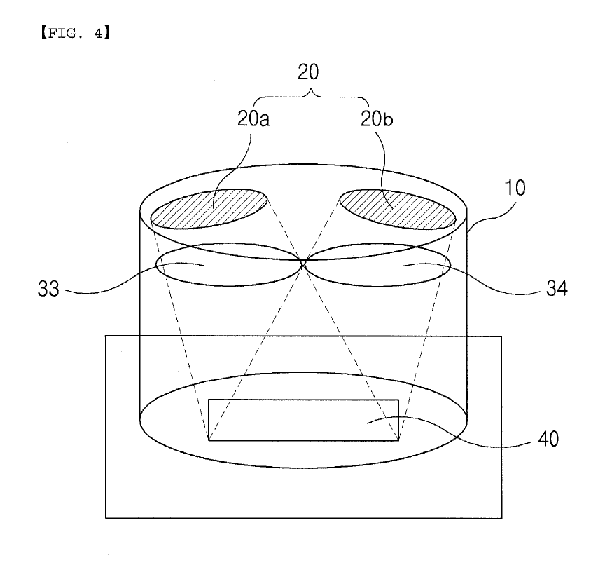

As shown in FIG. 4, in a third example of blocking films 33 and 34, the blocking films 33 and 34 having the same number as the number of lenses 20 and made of an opaque material are provided between the lenses 20 and the sensor 40 within the barrel 10 and are alternately changed to be transparent by an electrical signal. That is, in the third example, the blocking films 33 and 34 having the number corresponding to the number of lenses 20 and made of an opaque material are provided in a fixed state between the lenses 20 and the sensor 40 and are alternately changed to be transparent, thereby allowing the input images to be alternately sensed by the sensor.

The sensor 40, which is the same as the sensor used in the camera module according to the related art, corresponds to a component sensing the images input through the lenses.

According to the exemplary embodiments of the present invention, it is possible to implement a 3D image through a simple configuration including two lenses and a blocking film.

In addition, according to the exemplary embodiment of the present invention, images are alternately photographed through two camera lenses, thereby making it possible to simplify a process, in contrast with the 3D camera according to the related art requiring a troublesome process of photographing images using two cameras and then alternating the images obtained from the two cameras.

Further, a mechanical configuration of a camera module and a photographing scheme are simplified, thereby making it possible to simplify an algorithm operating the camera module.

As described above, although the present invention has been described with reference to exemplary embodiments and the accompanying drawings, it would be appreciated by those skilled in the art that the present invention is not limited thereto but various modifications and alterations might be made without departing from the scope defined in the claims and their equivalents.

What is claimed is:

1. A three-dimensional (3D) implementation camera module comprising:
a barrel;
at least two lenses embedded in the barrel;
a blocking film provided in the barrel to thereby alternately block the lenses; and
a sensor provided on a lower portion of the barrel to thereby sense images alternately input from the lenses.

2. The 3D implementation camera module according to claim 1, wherein the blocking film rotates within the barrel to thereby alternately block the lenses.

3. The 3D implementation camera module according to claim 1, wherein the blocking film is mounted on a rail provided in the barrel to move linearly, thereby alternately blocking the lenses.

4. The 3D implementation camera module according to claim 1, wherein the blocking films having the same number as the number of lenses and made of an opaque material are provided between the lenses and the sensor and are alternately changed to be transparent by an electrical signal.
